(19) United States
(12) Patent Application Publication
(10) Pub. No.: US 2025/0289290 A1
(43) Pub. Date: Sep. 18, 2025

(54) AIR VENTILATION AND LATCH RELEASE SYSTEM FOR FRUNK EQUIPPED VEHICLE

(71) Applicant: MAGNA CLOSURES INC., Newmarket (CA)

(72) Inventor: Stefan PAGE, Newmarket (CA)

(21) Appl. No.: 19/074,392

(22) Filed: Mar. 9, 2025

Related U.S. Application Data
(60) Provisional application No. 63/564,600, filed on Mar. 13, 2024.

(51) Int. Cl. B60H 1/28; B60J 10/80; B60R 5/02; B62D 25/12; E05B 77/00; E05B 83/24

(52) U.S. Cl. CPC B60H 1/28; B60R 5/02; B62D 25/12; E05B 77/00; B60J 10/80; E05B 83/243

(57) ABSTRACT

A latch system for a hood of a compartment of a motor vehicle includes a latch and a ventilation system including an air vent valve moveable between closed and open positions within an air passage extending between the compartment and an external environment. An actuation member of the latch system is configured to be disposed in the compartment for communication with the air vent valve and the latch, for actuation by a person. Actuation of the actuation member when the motor vehicle is traveling in excess of a predetermined speed causes the air vent valve to move to the open position to allow air from the external environment to flow into the compartment, with the latch remaining in the latched position. Actuation of the actuation member when the motor vehicle is traveling below the predetermined speed moves the latch from the latched position to the unlatched position.

### CROSS-REFERENCE TO RELATED APPLICATIONS

This application claims the benefit of U.S. Provisional Application Ser. No. 63/564,600, filed Mar. 13, 2024, which is incorporated herein by reference in its entirety.

### FIELD

The present disclosure relates to latch systems for motor vehicles, and more particularly, to latch systems for motor vehicle rear trunks and front trunks, also known as frunks.

### BACKGROUND

Latches for modern vehicle front trunks and rear trunks are typically actuated in two stages. During a first stage, a first release device, such as a handle, is actuated from inside the passenger compartment of the vehicle which moves the latch from a primary closed position to secondary closed position, wherein the latch is partially released, but still retains a striker of the hood to maintain the hood in a partially closed position and keeps the hood from being fully opened. When in the secondary closed position, air is generally able to pass from outside the trunk/frunk into the trunk/frunk through an air gap between the hood and the vehicle body, which can be desirable, particularly if a person is in the trunk/frunk.

Latches which can be unlatched in a multiple stage release actuations from inside of the trunk/frunk of the vehicle are also known. However, actuation of the latch is generally prohibited in certain conditions, such as when the vehicle is traveling above a predetermined rate of speed, such as 5 kph, for example. As such, if a person is trapped in the frunk/trunk, the latch is unable to be unlatched from the primary closed position to the secondary closed position in such prohibitive condition(s). In addition to the constraint(s) on being able to perform an unlatching of the latch, such double position latches are generally complex and costly.

Accordingly a latch system is desired that allows a person within a trunk/frunk to gain access to air from outside the trunk/frunk while trapped in the trunk/frunk and while the vehicle is operating in any operating state, with the latch system being economical in manufacture and use.

### SUMMARY

This section provides a general summary of the present disclosure and is not a comprehensive disclosure of its full scope or all of its features, aspects and objectives.

In accordance with an aspect of the disclosure, a latch system for a trunk and/or frunk, collectively referred to hereafter as hood, of a motor vehicle is provided that overcomes at least the disadvantages discussed above for known latch assemblies having primary, secondary, and full open positions.

In accordance with another aspect of the disclosure, a latch system for a hood of a compartment of a motor vehicle is provided. The latch system comprises a latch assembly including a ratchet mounted for movement between a striker capture position for retaining a striker fixed to the hood and an open position for releasing the striker, wherein the ratchet is biased toward the open position, and a pawl configured for operable communication with an actuation device and being mounted for movement between a ratchet holding position and a ratchet releasing position in response to actuation of the actuation device, the pawl being biased toward the rest position. The latch system further comprises a ventilation system including an air vent valve disposed for movement between a closed position and an open position within an air passage. While in the closed position, the air vent valve closes off the air passage and closes off the compartment from communication with an external environment, and while in the open position, the air vent valve opens the air passage and opens the compartment for communication with the external environment such that air from the environment can flow freely into the compartment. The latch system further comprises an actuation member configured to be disposed in the compartment for selective actuation by a person in the compartment. The actuation member being arranged in communication with the air vent valve to selectively move the air vent valve from the closed position to the open position, and in communication with the latch to move the pawl from the ratchet holding position to the ratchet releasing position. Actuation of the actuation member when the motor vehicle is traveling in excess a predetermined rate of speed causes the air vent valve to move from the closed position to the open position, but does not move the pawl from the ratchet holding position to the ratchet releasing position. Actuation of the actuation member when the motor vehicle is traveling below the predetermined rate of speed causes pawl to move from the ratchet holding position to the ratchet releasing position, and optionally causes the air vent valve to move from the closed position to the open position.

In accordance with another aspect of the disclosure, a latch and ventilation system for a hood of a compartment of a motor vehicle is provided. The latch and ventilation system has a latch assembly including a ratchet mounted for movement between a striker capture position for retaining a striker fixed to the hood, and a striker releasing position for releasing the striker, wherein the ratchet is biased toward the striker releasing position. Latch assembly further includes a pawl configured for operable communication with an actuation device and being mounted for movement between a ratchet holding position, whereat the pawl holds the ratchet in the striker capture position, and a ratchet releasing position, whereat the pawl releases the ratchet for movement to the striker releasing position, in response to actuation of the actuation device, with the pawl being biased toward the rest position. The latch and ventilation system also has a ventilation system including an air vent valve disposed for movement between a closed position and an open position within an air passage. While in the closed position, the air vent valve closes off the air passage and closes off the compartment from communication with an external environment, and while in the open position, the air vent valve opens the air passage and opens the compartment for communication with the external environment such that air from the external environment can flow freely into the compartment. The latch and ventilation system further includes an actuation member configured for selective actuation by a person in the compartment, with the actuation member being arranged in communication with the air vent valve to selectively move the air vent valve from the closed position to the open position.

In accordance with another aspect of the disclosure, the actuation member is configured in communication with the latch to move the pawl from the ratchet holding position to the ratchet releasing position.

In accordance with another aspect of the disclosure, the actuation member is arranged such that actuation of the actuation member when the motor vehicle is traveling in excess a predetermined rate of speed causes the air vent valve to move from the closed position to the open position, but does not move the pawl from the ratchet holding position to the ratchet releasing position.

In accordance with another aspect of the disclosure, the actuation member is arranged such that actuation of the actuation member when the motor vehicle is traveling below the predetermined rate of speed causes the pawl to move from the ratchet holding position to the ratchet releasing position.

In accordance with another aspect of the disclosure, the actuation member is arranged such that actuation of the actuation member when the motor vehicle is traveling below the predetermined rate of speed causes the air vent valve to move from the closed position to the open position.

In accordance with another aspect of the disclosure, the air passage is configured to extend directly from the compartment to the external environment.

In accordance with another aspect of the disclosure, the air passage is configured to extend into communication with an air chamber formed between the hood and the compartment, wherein the air chamber extends over a seal between the hood and the compartment.

In accordance with another aspect of the disclosure, the actuation member can be configured for selective actuation by a person outside the compartment.

In accordance with another aspect of the disclosure, the actuation member is arranged such that actuation of the actuation member when the motor vehicle is traveling in excess a predetermined rate of speed causes the air vent valve to move from the closed position to the open position, but does not move the pawl from the ratchet holding position to the ratchet releasing position.

In accordance with another aspect of the disclosure, the air vent valve is a butterfly valve.

In accordance with another aspect of the disclosure, a motor vehicle is provided, including, a hood moveable between a closed position to close off a compartment of the motor vehicle and an open position to open the compartment. Motor vehicle further includes a latch assembly including a ratchet mounted for movement between a striker capture position for retaining a striker fixed to the hood and a striker releasing position for releasing the striker, wherein the ratchet is biased toward the striker releasing position, and a pawl configured for operable communication with an actuation device and being mounted for movement between a ratchet holding position, whereat the pawl holds the ratchet in the striker capture position, and a ratchet releasing position, whereat the pawl releases the ratchet for movement to the striker releasing position, in response to actuation of the actuation device, the pawl being biased toward the rest position. Motor vehicle further includes a ventilation system including an air vent valve disposed for movement between a closed position and an open position within an air passage. While air vent valve is in the closed position, the air vent valve closes off the air passage and closes off the compartment from communication with an external environment, and while air vent valve is in the open position, the air vent valve opens the air passage and opens the compartment for communication with the external environment such that air from the external environment can flow freely into the compartment. An actuation member is configured for selective actuation from within the compartment, with the actuation member being arranged in communication with the air vent valve to selectively move the air vent valve from the closed position to the open position.

In accordance with another aspect of the disclosure, a method of configuring operation of a latch and ventilation system of a hood of a compartment of a motor vehicle is provided. The method includes providing an actuation member, an actuation device, and providing the latch and ventilation system having a latch assembly and a ventilation system. The latch assembly including a ratchet mounted for movement between a striker capture position for retaining a striker fixed to the hood and a striker releasing position for releasing the striker, wherein the ratchet is biased toward the striker releasing position, and a pawl configured for operable communication with the actuation device and being mounted for movement between a ratchet holding position, whereat the pawl holds the ratchet in the striker capture position, and a ratchet releasing position, whereat the pawl releases the ratchet for movement to the striker releasing position, the pawl being biased toward the rest position. The ventilation system including an air vent valve disposed for movement between a closed position and an open position within an air passage, wherein while in the closed position, the air vent valve closes off the air passage and closes off the compartment from communication with an external environment, and while in the open position, the air vent valve opens the air passage and opens the compartment for communication with the external environment such that air from the external environment can flow freely into the compartment. The method further includes configuring the actuation member for selective actuation by a person in the compartment, with the actuation member being arranged in operable communication with the actuation device and with the air vent valve to selectively move the air vent valve from the closed position to the open position and to selectively signal the actuation device to move the pawl from the ratchet holding position to the ratchet releasing position.

In accordance with another aspect of the disclosure, the method further includes configuring the actuation member to move the air vent valve from the closed position to the open position when the motor vehicle is traveling in excess of a predetermined rate of speed but not move the pawl from the ratchet holding position to the ratchet releasing position when the motor vehicle is traveling in excess of the predetermined rate of speed.

In accordance with another aspect of the disclosure, the method further includes configuring the actuation member to optionally move the air vent valve from the closed position to the open position when the motor vehicle is traveling below the predetermined rate of speed and to signal the actuation device to move the pawl from the ratchet holding position to the ratchet releasing position when the motor vehicle is traveling below the predetermined rate of speed.

In accordance with another aspect, there is provided a vehicle having a storage compartment, a closure panel for sealing the storage compartment, the closure panel moveable between a closed position and an open position, and a ventilation system having a closed state and an open state, wherein the ventilation system in the closed state allows airflow into the storage compartment while the closure panel is in the closed position.

In a related aspect, the storage compartment is a frunk storage compartment.

### BRIEF DESCRIPTION OF THE DRAWINGS

These and other objects, features, and advantages of the present disclosure will be readily appreciated, as the same becomes better understood by reference to the following detailed description when considered in connection with the accompanying drawings wherein:

FIG. 1A is a fragmentary perspective view of motor vehicle having a latch system in accordance with one aspect of the disclosure;

FIG. 1B is a partial perspective view of some components of a latch of a latch system of the motor vehicle;

FIG. 2 is a side view of the motor vehicle of FIG. 1A with the latch of the latch system shown in a fully latched position;

FIG. 3A is a view similar to FIG. 2 showing an air vent of the latch system moved from a closed position to an open position to allow air from outside a frunk to enter the frunk;

FIG. 3B is a view similar to FIG. 3A showing an air vent of the latch system in accordance with another aspect of the disclosure;

FIG. 4 is a flow diagram illustrating a method of operating a latch system in accordance with another aspect of the disclosure to allow air to enter a frunk and/or trunk under different operating conditions of a motor vehicle; and

FIG. 5 is a flow diagram illustrating a method of configuring operation of a latch and ventilation system of a hood of a compartment of a motor vehicle.

### DETAILED DESCRIPTION OF EXAMPLE EMBODIMENTS

In general, example embodiments of a latch system constructed in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

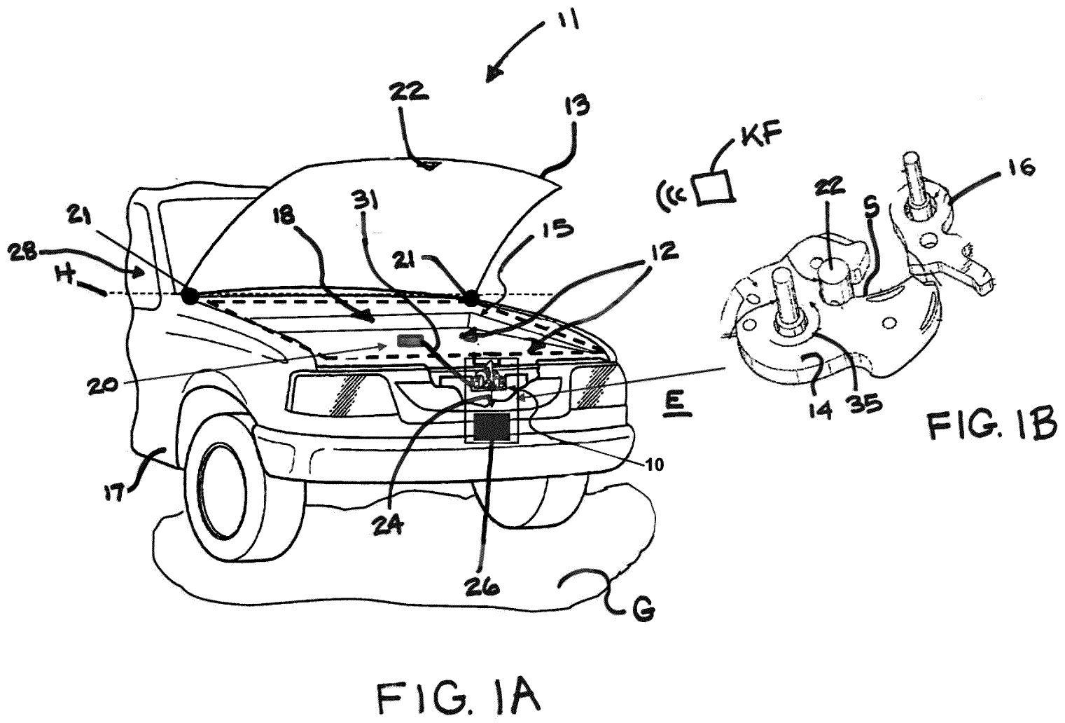

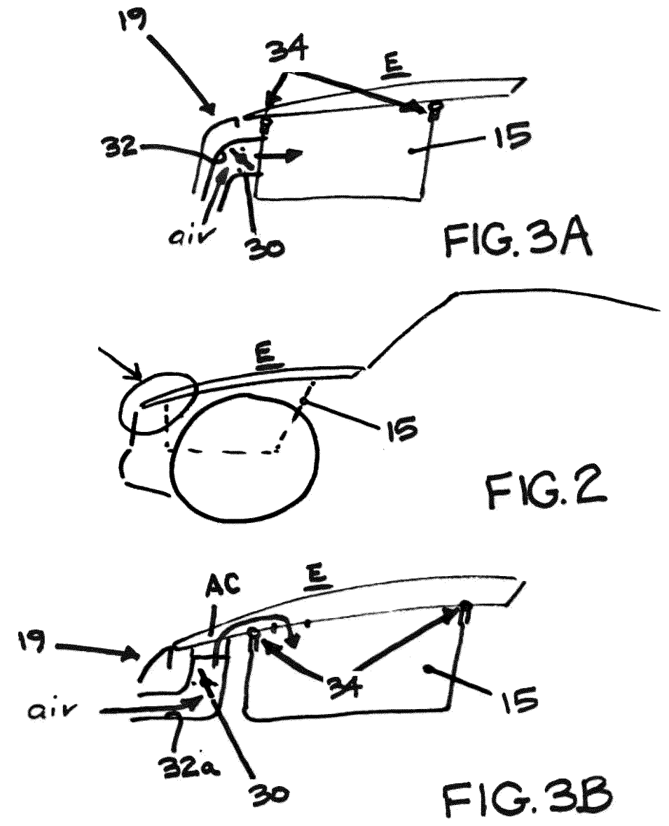

Reference is made to FIG. 1A, which shows a motor vehicle 11 that has a closure panel, shown as a front hood 13, to which a striker 22 is fixedly attached. Front hood, also referred to as hood 13, may enclose an opening providing a compartment, shown as a front trunk 15, also referred to as frunk 15, for storage in a compartment provided in the front of the vehicle 11 where an engine typically would occupy, but has been provided at another location in the vehicle. The striker 22 is capturable by a latch assembly, also referred to as latch 10, of a latch and ventilation system 12, which is mounted on a vehicle body 17 of the motor vehicle 11, wherein hood 13 is locked in a fully closed position when striker 22 is in a primary latched state.

Hood 13, as permitted by latch 10, can be moved from the fully closed position to a fully open position, whereat hood 13 is pivoted about a hinge axis H defined by hinges 21, and striker 22 is removed from latch 10 (FIG. 1) to provide access to the stowage space, or frunk 17.

Latch 10, as shown in FIG. 1B, includes a ratchet 14 and a pawl 16. A communication linkage system or arrangement, also referred to as release member, such as cable assembly and/or electrical member 24, operably interconnects pawl 16 to an actuation device 26 (FIG. 1A), wherein an actuation member 20, configured to signal the actuation device 26 for selectively energizing the actuation device 26, can be located within a passenger compartment 28 of motor vehicle 11, or elsewhere, as desired. The actuation member 20 can further be provided for selective actuation of the actuation device 26 by a person outside the compartment 15, such as from inside the passenger compartment 28 and/or via an electronic key fob KF, by way of example and without limitation.

The ratchet 14, as well understood in the art of motor vehicle latches, is pivotably connected to a latch housing, also referred to as housing. Ratchet 14 is movable between a striker capture position, also referred to as closed position, and a striker release position, also referred to as open position. Ratchet 14 is biased by a ratchet biasing member 35 toward the open position, shown as being in a counterclockwise direction indicated by arrow 35 (FIG. 1). Ratchet 14 has a slot S, as is known, for locking receipt of striker 22 therein while in a striker capture position, corresponding to the closed or partially closed position of hood 13.

Pawl 16 is configured for movement between a latched position, also referred to as ratchet holding position, whereat the pawl 16 releasably locks the ratchet 14 in the striker capture position, and an unlatched position, also referred to as ratchet releasing position, whereat the pawl 16 releases the ratchet 14 for free movement under a bias imparted by ratchet biasing member 35 to the open position. It is understood that latch 10 may be provided in various configurations, such as a single pull latch requiring a single actuation (e.g. a single pull from a cable) to fully release the striker 22 from the ratchet 14, a double pull latch requiring a double actuation (e.g. a double pull from a cable) to fully release the striker 22 from the ratchet 14, and may include other striker 22 retaining mechanisms such as a safety hook, a single pawl, or a double pawl configurations, without limitation.

Latch and ventilation system 12 further includes a ventilation system 18 having a ventilation mechanism 19. Ventilation mechanism 19 includes an actuation member 20, such as a button, switch, lever, by way of example and without limitation, located within frunk 15, and an air vent valve, also referred to as valve 30 (FIG. 3A). Actuation member 20 is in operable communication with latch 10 and valve 30, such as via any suitable electrical communication, including wire(s) 31, by way of example and without limitation. Valve 30 is an example of a mechanism allowing the ventilation system 12 in a closed state where air flow is prevented from entering into the frunk 15 via the ventilation system 12 and an open state where air flow is allowed to enter into the frunk 15 via the ventilation system 12. Valve 30 is moveable, in response to selective actuation of actuation member 20, such as by a person in frunk 15, from a closed position to an open position. When valve 30 is in the closed position, an air passage 32 extending between frunk 15 and an external environment E of motor vehicle 11 is closed off, thereby closing off frunk 15 from communication with external environment E such that frunk 15 is generally sealed off from communication with the external environment E, which can be facilitated by one or more seals 34 compressed between hood 13 and body 17. When valve 30 is moved to the open position, air passage 32 brings frunk 15 into open communication with the external environment E outside of frunk 15, such that air from the outside environment E can flow freely into frunk 15. Valve 30 can be provided as any type of valve capable of opening and closing the air passage 32, such as a butterfly valve pivotable about an axis between open and closed positions to open and close the air passage 32 to the flow of air, respectively. Movement of valve 30 from the closed position to the open position can occur via selective actuation of actuation member 20 regardless of the operation state of motor vehicle 11, such that motor vehicle 11 can be at rest relative to a ground surface G, or traveling at any rate of speed relative to ground surface G. However, if motor vehicle 11 is traveling above a predetermined rate of speed relative to ground surface G, such as 5 kph, by way of example and without limitation, latch 10, even if attempted to be unlatched, remains in its fully latched, closed state. Air passage 32 can be routed in any number of ways to communicate frunk 15 with the environment E, and is shown in FIG. 3A as extending directly from frunk 15 to environment E through a front end of motor vehicle 11. In another non-limiting embodiment illustrated in FIG. 3B, air valve 30a, operational as discussed above for air valve 30, is disposed in an air passage 32a shown extending into communication with an air chamber AC extending between hood 13 and frunk 15, and over a seal 34, by way of example and without limitation.

When the closure panel 13 is in a closed position and the ventilation system 12 in a closed state e.g. valve 30 is closed, the frunk 15 may be sealed against air flow between the closure panel 13 and the vehicle body 17, as a result of the one or more seals 34 compressed between hood 13 and body 17. The ventilation system 12 maybe transitioned from the closed state to an open state whereby airflow is allowed into the frunk storage compartment 15 while the closure panel 13 remain is in the closed position. In other words, with the closure panel 13 in the closed position the one or more seals 34 compressed between hood 13 and body 17 to prevent airflow from entering into the frunk 13 past the one or more seals 34, while airflow may be allowed to move into and out of the frunk 13 via the ventilation system 12 e.g. through the conduit 32.

If motor vehicle 11 is operating within a predetermined set of parameter(s), such as traveling below a predetermined rate of speed relative to ground surface G, such as 5 kph, by way of example and without limitation, latch 10 can be actuated via actuation of actuation member 20, whereupon latch 10 moves to its fully unlatched, open state. Accordingly, a person trapped in frunk 15, while motor vehicle is at rest or traveling below the predetermined rate of speed relative to ground surface G, can readily open hood 13 to breathe air from the environment E and exit frunk 15. It is understood that ventilation mechanism 19 may be operated independently, and not in coordination with latch 10 or the predetermined set of parameter(s). For example, valve 30 of ventilation mechanism 19 may be moveable from a closed position to an open position after the latch assembly 10 has been released, for example when the closure panel 13 is in an open position in preparation for the return of the closure panel 13 to a closed position, which may occur during a user slamming the hood 13 closed. With the valve 30 in an open position, air being moved or compressed by the closure panel 13 within the frunk 15 may be allowed to escape via the air passage 32 to thereby alleviate any excessive air pressure build up preventing the slam event from causing the latch 10 to properly engage the striker 22. For example, valve 30 of ventilation mechanism 19 may be moveable from a closed position to an open position after an active pedestrian protection event has been detected causing the closure panel 13 to be moved from a closed position to a raised position, under the force of a pyrotechnic device. For example when the closure panel 13 is in an closed position and an imminent or actual impact with a pedestrian has been detected using a sensor system e.g. collision detection system, a pyrotechnic actuator provided in the hinges 21 and/or latch 10 may output a force to raise the hood from the close position to an active pedestrian position in which the hood 13 may be moved away from the vehicle body 17 to cushion the impact of a pedestrian against the hood 13. By opening up the valve 30 prior to or during the firing of the pyrotechnic actuator, additional air may be fed into the frunk 15 via the air passage 32 to reduce the effort of the pyrotechnic actuator to raise the frunk 15 by eliminating a vacuum effect of the sealed frunk 15 by the hood 13. The speed of deployment of the frunk 15 may also be increased due to a reduction in the force need to raise the frunk 15. US Patent Application Number 2023/0356688A1 to Sardelli, et. al., filed May 2, 2023, entitled, “Actuation system for a closure panel including a pop up safety system for hinges,” illustratively describes a hood hinge having a pyrotechnic actuator and is incorporated herein by reference in its entirety. US Patent Application Number US Patent Number 2021/0293058A1 to Szente, et al., filed Jun. 7, 2021, entitled “Actuated mechanism for active pedestrian safety latch” illustratively describes a hood latch having a pyrotechnic actuator and is incorporated herein by reference in its entirety.

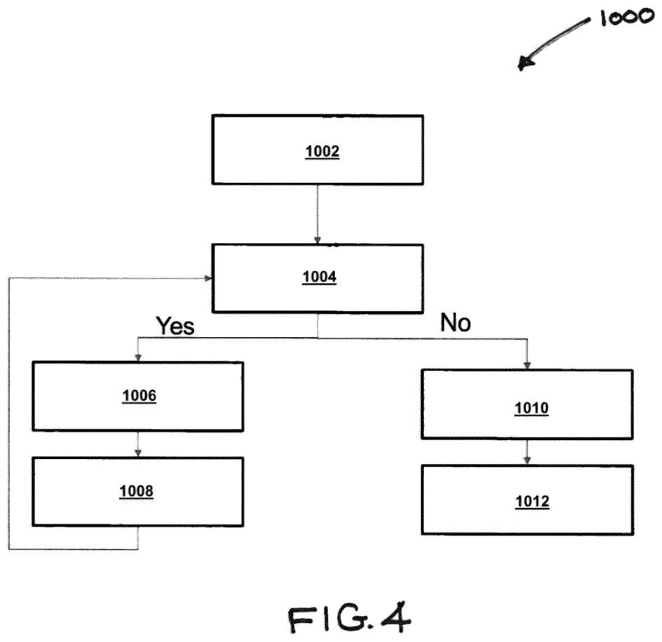

In FIG. 4, a flow diagram illustrates a method of operation 1000 of latch and ventilation system 12, both while motor vehicle 11 is traveling above and below a predetermine rate of speed relative to ground surface G. As shown, activation of actuation member 20 while motor vehicle 11 is traveling in excess of the predetermined rate of speed does not cause latch 10 to be unlatched, however, it does cause air vent valve 30 to be moved from its closed position to its open position, thereby allowing air to flow freely through air passage 32 into frunk 15. On the other hand, while motor vehicle 11 is traveling below the predetermined rate of speed, activation of actuation member 20 causes latch 10 to be unlatched, and optionally, can cause air vent valve 30 to be moved from its closed position to its open position, thereby allowing hood 13 to be fully opened and optionally, air to flow freely through air passage 32 into frunk 15. The method illustratively includes the steps of detecting a switch activation from within the frunk compartment 1002, followed by the step 1004 of determining if the vehicle speed is above a predetermined vehicle speed, such as 5 kph for example. If the determination at step 1004 is Yes, the method 1000 proceeds to step 1006 including not powering releasing the latch, followed by the step 1008 of opening the air vent. If the determination at step 1004 is No, the method 1000 proceeds to step 1010 including powering releasing the latch, followed by the optional step 1012 of opening the air vent.

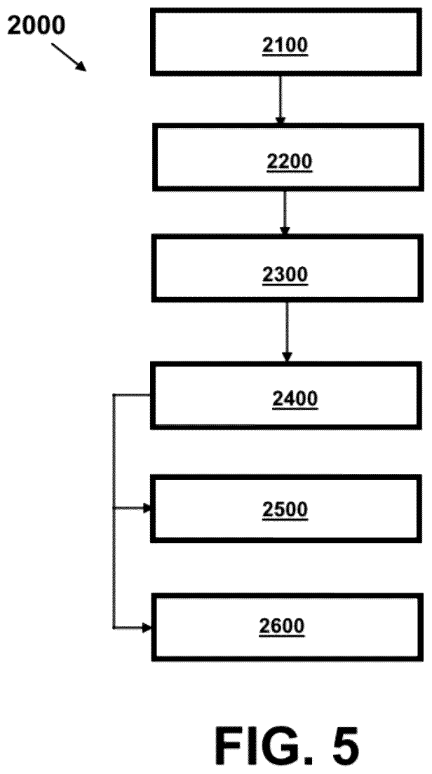

In FIG. 5, a method 2000 of configuring operation of a latch and ventilation system 12 of a hood 13 of a compartment 15 of a motor vehicle 11 is illustrated. The method 2000 includes a step 2100 of providing an actuation member 20, a step 2200 of providing an actuation device 26, and a step 2300 of providing the latch and ventilation system 12 having a latch assembly 10 and a ventilation system 18. The latch assembly 10 including a ratchet 14 mounted for movement between a striker capture position for retaining a striker 22 fixed to the hood 13 and a striker releasing position for releasing the striker 22, wherein the ratchet 14 is biased toward the striker releasing position, and a pawl 16 configured for operable communication with the actuation device 26 and being mounted for movement between a ratchet holding position, whereat the pawl 16 holds the ratchet 14 in the striker capture position, and a ratchet releasing position, whereat the pawl 16 releases the ratchet 14 for movement to the striker releasing position, the pawl 16 being biased toward the rest position. The ventilation system 18 including an air vent valve 30 disposed for movement between a closed position and an open position within an air passage 32, wherein while in the closed position, the air vent valve 30 closes off the air passage 32 and closes off the compartment 15 from communication with an external environment E, and while in the open position, the air vent valve 30 opens the air passage 32 and brings the compartment 15 into communication with the external environment E such that air from the external environment E can flow freely into the compartment 15, even while hood 13 is closed. The method 2000 further includes a step 2400 of configuring the actuation member 20 for selective actuation by a person in the compartment 15, with the actuation member 20 being arranged in operable communication with the actuation device 26 and with the air vent valve 30 to selectively move the air vent valve 30 from the closed position to the open position and to selectively signal the actuation device 26 to move the pawl 16 from the ratchet holding position to the ratchet releasing position.

The method 2000 further includes a step 2500 of configuring the actuation member 20 to move the air vent valve 30 from the closed position to the open position when the motor vehicle 11 is traveling in excess of a predetermined rate of speed but not move the pawl 16 from the ratchet holding position to the ratchet releasing position.

The method 2000 further includes a step 2600 of configuring the actuation member 20 to optionally move the air vent valve 30 from the closed position to the open position when the motor vehicle 11 is traveling below the predetermined rate of speed and to signal the actuation device 26 to move the pawl 16 from the ratchet holding position to the ratchet releasing position when the motor vehicle 11 is traveling below the predetermined rate of speed.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A latch and ventilation system for a hood of a compartment of a motor vehicle, comprising:
a latch assembly including:
a ratchet mounted for movement between a striker capture position for retaining a striker fixed to the hood and a striker releasing position for releasing the striker, wherein the ratchet is biased toward the striker releasing position;
a pawl configured for operable communication with an actuation device and being mounted for movement between a ratchet holding position, whereat the pawl holds the ratchet in the striker capture position, and a ratchet releasing position, whereat the pawl releases the ratchet for movement to the striker releasing position, in response to actuation of the actuation device, the pawl being biased toward the rest position;
a ventilation system including:
an air vent valve disposed for movement between a closed position and an open position within an air passage, wherein while in the closed position, the air vent valve closes off the air passage and closes off the compartment from communication with an external environment, and while in the open position, the air vent valve opens the air passage and opens the compartment for communication with the external environment such that air from the external environment can flow freely into the compartment; and
an actuation member configured for selective actuation by a person in the compartment, the actuation member being arranged in communication with the air vent valve to selectively move the air vent valve from the closed position to the open position.

2. The latch and ventilation system of claim 1, wherein the actuation member is configured in communication with the latch to move the pawl from the ratchet holding position to the ratchet releasing position.

3. The latch and ventilation system of claim 2, wherein the actuation member is arranged such that actuation of the actuation member when the motor vehicle is traveling in excess of a predetermined rate of speed causes the air vent valve to move from the closed position to the open position, but does not move the pawl from the ratchet holding position to the ratchet releasing position.

4. The latch and ventilation system of claim 3, wherein the actuation member is arranged such that actuation of the actuation member when the motor vehicle is traveling below the predetermined rate of speed causes the pawl to move from the ratchet holding position to the ratchet releasing position.

5. The latch and ventilation system of claim 4, wherein the actuation member is arranged such that actuation of the actuation member when the motor vehicle is traveling below the predetermined rate of speed causes the air vent valve to move from the closed position to the open position.

6. The latch and ventilation system of claim 1, wherein the air passage is configured to extend directly from the compartment to the external environment.

7. The latch and ventilation system of claim 1, wherein the air passage is configured to extend into communication with an air chamber formed between the hood and the compartment, wherein the air chamber extends over a seal between the hood and the compartment.

8. The latch and ventilation system of claim 1, wherein the actuation member is configured for selective actuation by a person outside the compartment.

9. The latch and ventilation system of claim 8, wherein the actuation member is arranged such that actuation of the actuation member when the motor vehicle is traveling in excess a predetermined rate of speed causes the air vent valve to move from the closed position to the open position, but does not move the pawl from the ratchet holding position to the ratchet releasing position.

10. The latch and ventilation system of claim 1, wherein the air vent valve is a butterfly valve.

11. A motor vehicle, comprising:
a hood moveable between a closed position to close off a compartment of the motor vehicle and an open position to open the compartment;
a latch assembly including:
a ratchet mounted for movement between a striker capture position for retaining a striker fixed to the hood and a striker releasing position for releasing the striker, wherein the ratchet is biased toward the striker releasing position;
a pawl configured for operable communication with an actuation device and being mounted for movement between a ratchet holding position, whereat the pawl holds the ratchet in the striker capture position, and a ratchet releasing position, whereat the pawl releases the ratchet for movement to the striker releasing position, in response to actuation of the actuation device, the pawl being biased toward the rest position;
a ventilation system including:
an air vent valve disposed for movement between a closed position and an open position within an air passage, wherein while in the closed position, the air vent valve closes off the air passage and closes off the compartment from communication with an external environment, and while in the open position, the air vent valve opens the air passage and opens the compartment for communication with the external environment such that air from the external environment can flow freely into the compartment; and
an actuation member configured for selective actuation from within the compartment, the actuation member being arranged in communication with the air vent valve to selectively move the air vent valve from the closed position to the open position.

12. The motor vehicle of claim 11, wherein the actuation member is configured in communication with the latch to move the pawl from the ratchet holding position to the ratchet releasing position.

13. The motor vehicle of claim 12, wherein the actuation member is arranged such that actuation of the actuation member when the motor vehicle is traveling in excess of a predetermined rate of speed causes the air vent valve to move from the closed position to the open position, but does not move the pawl from the ratchet holding position to the ratchet releasing position.

14. The motor vehicle of claim 13, wherein the actuation member is arranged such that actuation of the actuation member when the motor vehicle is traveling below the predetermined rate of speed causes the pawl to move from the ratchet holding position to the ratchet releasing position.

15. The motor vehicle of claim 14, wherein the actuation member is arranged such that actuation of the actuation member when the motor vehicle is traveling below the predetermined rate of speed causes the air vent valve to move from the closed position to the open position.

16. The motor vehicle of claim 11, wherein the air passage is configured to extend directly from the compartment to the external environment.

17. The motor vehicle of claim 11, wherein the air passage is configured to extend into communication with an air chamber formed between the hood and the compartment, wherein the air chamber extends over a seal between the hood and the compartment.

18. The motor vehicle of claim 11, wherein the actuation member is configured for selective actuation by a person outside the compartment.

19. The motor vehicle of claim 18, wherein the actuation member is arranged such that actuation of the actuation member when the motor vehicle is traveling in excess of a predetermined rate of speed causes the air vent valve to move from the closed position to the open position, but does not move the pawl from the ratchet holding position to the ratchet releasing position.

20. A vehicle comprising:
a frunk storage compartment;
a closure panel for sealing the storage compartment, the closure panel moveable between a closed position and an open position; and
a ventilation system having a closed state and an open state, wherein the ventilation system in the closed state allows airflow into the frunk storage compartment while the closure panel is in the closed position.
